(19) United States
(12) Patent Application Publication
(10) Pub. No.: US 2025/0313112 A1
(43) Pub. Date: Oct. 9, 2025

(54) AUTONOMOUS DECENTRALIZED CHARGE CONTROLLER OF ELECTRIC VEHICLES

(71) Applicant: KING FAHD UNIVERSITY OF PETROLEUM AND MINERALS, Dhahran (SA)

(72) Inventors: Md Ismail HOSSAIN, Dhahran (SA); Ali T. AL-AWAMI, Dhahran (SA); Mohamed Ali Yousef ABIDO, Dhahran (SA)

(73) Assignee: KING FAHD UNIVERSITY OF PETROLEUM AND MINERALS, Dhahran (SA)

(21) Appl. No.: 18/654,740

(22) Filed: May 3, 2024

(30) Foreign Application Priority Data
Apr. 4, 2024 (SA) 1020241820

(51) Int. Cl. B60L 53/63; B60L 53/62; B60L 53/67

(52) U.S. Cl. CPC B60L 53/63; B60L 53/62; B60L 53/67

(57) ABSTRACT

A device and method for managing the charging process of multiple electric vehicles connected to a power distribution system. The method involves determining voltage change tolerance by monitoring local grid voltages at various time points in proximity to an electric vehicle located at an upstream node. Subsequent measurements of grid voltage and the vehicle's state of charge and battery voltage are used to decide on an appropriate charging mode, whether constant current (CC) or constant voltage (CV), depending on how the measured battery voltage compares to a predefined maximum battery voltage. The method further involves assessing the EV's battery voltage and state of charge to determine the optimal charging mode, and then calculating a precise charging current based on these parameters. By systematically analyzing local grid voltages and battery conditions, the method adjusts the charging current dynamically.

### CROSS REFERENCE TO RELATED APPLICATION

The present disclosure claims the benefit of Saudi patent application Ser. No. 1020241820 filed on Apr. 4, 2024, with the Saudi Authority for Intellectual Property Office, which is incorporated herein by reference in its entirety.

### STATEMENT OF ACKNOWLEDGEMENT

The present invention is supported by the National Science, Technology and Innovation Plan (NSTIP) through the funded project #14-ENE360-04-R.

### BACKGROUND

### Technical Field

The present disclosure is directed to the field of controlled decentralized charging of electric vehicles.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The foundation of economic and technological progress rests upon a dependable and readily available source of energy. However, traditional fossil fuels, currently serving as primary energy sources, are finite and cannot entirely fulfill the increasing electricity demand. Fossil fuels also pose significant environmental challenges. Such challenges have spurred a global requisite for more utilization of renewable energy sources, such as solar and wind power, for power generation. Renewable energy resources offer a seemingly limitless supply of clean energy. Despite their abundance, renewable energy sources present an obstacle to their intermittent nature. Solar energy production fluctuates significantly based on daylight hours and weather conditions, while wind energy varies depending on wind speed and direction. This intermittency creates a mismatch between energy generation and consumer demand, posing a significant hurdle in seamlessly integrating these resources into the existing power grid infrastructure.

Energy storage systems (ESS) have been developed to address the intermittency challenge. By functioning as a buffer, ESS can store excess energy generated during peak production periods of renewable sources and subsequently release it during times of high demand. Such ability to bridge the gap between renewable energy generation and consumer needs results in maximizing the utilization of these clean energy sources.

Among various ESS technologies, battery energy storage systems (BESS) have gained significant attention due to their declining costs, high energy density, and extended cycle efficiency. Therefore, BESS has been preferred for large-scale energy storage applications, particularly when integrated with renewable energy generation systems. To mitigate the fluctuations caused by factors like temperature shifts, varying wind speeds, and solar radiation changes, energy storage systems are being deployed alongside renewable energy installations. Supercapacitors and flywheel energy storage systems offer rapid response times, but their widespread use is limited due to their high cost and significant energy loss.

In addition to large-scale battery energy storage for grid applications, the transportation sector is undergoing a significant transformation with the rising popularity of electric vehicles (EVs). As environmental concerns escalate, consumers are increasingly opting for EVs, leading to a rapid rise in their adoption. However, the large-scale integration of EVs into the current distribution grid system presents a new set of challenges.

Unregulated charging of EVs can significantly impact grid stability. If a large number of EVs connect to the grid and initiate charging simultaneously, it can lead to feeder overloads, increased system power losses, and voltage fluctuations. These instabilities can have cascading effects, potentially leading to blackouts or damage to critical grid infrastructure.

Centralized control methods have been implemented as a potential solution to manage EV charging and ensure grid stability. These methods rely on a central controller that gathers data on EV status, owner information, system variables like market prices and loading, and other relevant constraints. Based on this data, the central controller can then orchestrate and control the charging of EVs to optimize grid stability.

While centralized control is an advantageous method, it poses certain limitations. These centralized control systems depend on continuous communication with all connected EVs. In one example, a communication-based centralized control gathers data from EVs and the power grid to centrally orchestrate charging schedules that optimize grid stability. Any disruption in this communication, whether due to technical issues or malicious intent, can lead to a loss of control and potentially destabilize the grid. Additionally, the implementation of centralized control requires significant investments in robust communication infrastructure, stringent safety measures to mitigate cyberattacks, and high-performance computing power to handle the large volume of data in a real-time.

Another example of a control system includes decentralized control methods. These methods are implemented to achieve grid stability without relying on extensive communication between EVs and a central controller. One decentralized method is based on time-varying electricity pricing to incentivize EV owners to charge their vehicles during off-peak hours. However, this method may not be effective in all situations, as electricity prices may not always reflect real-time grid conditions.

Furthermore, a few known conventional systems propose hybrid technologies that combine elements of centralized and decentralized control. These methods aim to leverage the strengths of both methods while mitigating their limitations. For instance, a hybrid system might use a central controller to provide coarse-grained guidance to EVs while allowing the system to make localized charging decisions based on real-time grid conditions.

Therefore, it can be understood that each of the centralized, decentralized, or hybrid control systems poses certain limitations. Referring back to the centralized control system, several control methods have been implemented to overcome the limitations of the centralized control system. One example of the centralized control method includes treating EVs as additional voltage controllers within the system. According to the method, coordinated EVs with transformers adjust their charging and discharging behavior in response to fluctuations in solar energy generation. While effective for voltage control, the method exhibited limitations on EV mobility.

Another example of the centralized control method includes utilizing large-scale EV battery energy storage systems (BESS) in conjunction with conventional frequency regulation resources for grid management. In this method, EVs are configured to support grid frequency regulation but acknowledged that Automatic Generation Control (AGC) remains necessary for handling longer-duration disturbances.

In yet another example, centralized control includes the use of vehicle-to-grid (V2G) systems for load frequency management, particularly with wind energy integration. The V2G systems can significantly reduce the reliance on traditional generators for regulation purposes. However, the impact of V2G activities on the distribution system and the required significant communication bandwidth for dispatching EVs is adverse. Additionally, the optimization algorithms placed high computational demands on the centralized controller.

Conventional methods relate to balancing customer convenience with network constraints while coordinating plug-in EV charging. These methods are based on multi-objective optimization techniques but rely on constant communication between various entities and the required knowledge of load profiles.

Other methods based on economic-based charge control relate to loss optimization and price-based approaches. While loss optimization effectively flattened load profiles, price-based approaches might lead to distribution system overloads during low-price periods. These methods also heavily relied on a robust communication infrastructure.

A hierarchical control method with three levels, in one example, is implemented for coordinating EV charging at a provincial level. The hierarchical control method transmits user preferences for aggregation with other loads and pricing periods. While effective in a specific utility system, this method is prone to network limitations or generation constraints.

Despite potential benefits, centralized control systems face limitations. Significant investment is required in communication infrastructure to handle the large volumes of data transmission needed for real-time control. This can lead to communication challenges like high latency and poor quality of service. Additionally, processing large amounts of data incurs significant computational costs. Furthermore, the integrity of the system can be compromised by loss of communication or issues with the central controller.

Conventional technologies offer various methods for managing EV charging and ensuring grid stability. However, they all have certain limitations. Centralized control methods are susceptible to communication disruptions and require significant infrastructure investment. Decentralized control methods, while mitigating communication dependence, may not always be effective in achieving optimal grid stability. Hybrid systems attempt to address these limitations but may introduce additional complexity.

Therefore, there remains a need for a more robust, efficient, and cost-effective solution to manage EV charging and facilitate the integration of renewable energy sources into the power grid.

### SUMMARY

In an exemplary embodiment, a method for controlling charging of a plurality of electric vehicles electrically connected to a power distribution system is disclosed. The method includes determining a voltage change tolerance based on a first local grid voltage of the power distribution system at a first time point and a second local grid voltage of the power distribution system at a second time point. The first time point is prior to the second time point, and the first and second local grid voltages are measured within a first range from a first electric vehicle of the plurality of electric vehicles located at an upstream node in the power distribution system.

The method further includes measuring a third local grid voltage of the power distribution system at a third time point, a fourth local grid voltage of the power distribution system at a fourth time point, a first state of charge of the first electric vehicle of the plurality of electric vehicles at the fourth time point, and a first battery voltage of the first electric vehicle of the plurality of electric vehicles at the fourth time point. The third time point is prior to the fourth time point and after the second time point, and the third and fourth local grid voltages are measured within the first range of the first electric vehicle of the plurality of electric vehicles.

The method further includes comparing the first battery voltage and a first maximum battery voltage to determine a first charging mode of the first electric vehicle of the plurality of electric vehicles and determining a first charging current of the first electric vehicle of the plurality of electric vehicles based on the third and fourth local grid voltages, the first state of charge, and the first battery voltage.

In one aspect of the present disclosure, the first charging mode is selected from the group consisting of a minimum charging mode, a maximum charging mode, a variable charging mode, a constant charging mode, and a stop charging mode.

In one aspect of the present disclosure, the first charging mode is the variable charging mode and wherein the first charging current is determined in accordance with:

$${I}_{EV} = {I}_{m ax} - {k}_{p} min ( {ΔV}_{m ax} , ( {V}_{r} - {V}_{k} ( t ) ) + {μ}_{k} ( t ) ;$$

wherein I_{EV} is the charging current, Iₘₐₓ a maximum charging current, kₚ is a first scaling factor, ΔVₘₐₓ is maximum voltage deviation from a nominal grid voltage, Vᵣ is the nominal grid voltage, Vₖ(t) is the second local grid voltage, and μₖ(t) is a weight, wherein μₖ(t)=min (μₘₐₓ, b(Vᵣ−Vₖ(t)), wherein b is a second scaling factor and μₘₐₓ is a maximum weight.

In one aspect of the present disclosure, the weight is determined based on the third and fourth local grid voltages of the first electric vehicle of the plurality of electric vehicles measured within the first range from the first electric vehicle of the plurality of electric vehicles, a fifth local grid voltage of the power distribution system at the third time point, a sixth local grid voltage of the power distribution system at the fourth time point, a second state of charge of a second electric vehicle of the plurality of electric vehicles at the fourth time point, and a second battery voltage of the second electric vehicle of the plurality of electric vehicles at the fourth time point. The fifth and sixth local grid voltages are measured within a second range from the second electric vehicle of the plurality of electric vehicles. The second electric vehicle is located at a downstream node in the power distribution system.

In one aspect of the present disclosure, the measuring the third local grid voltage, the comparing, and the determining are repeated until the first charging mode is changed to the minimum charging mode, the maximum charging mode, the constant charging mode, or the stop charging mode.

In one aspect of the present disclosure, the upstream node and the downstream node in the power distribution system exclude a communication system for a decentralized charging control.

In one aspect of the present disclosure, the first local grid voltage is less than or equal to a threshold voltage, the first charging mode is the minimum charging mode, and the first charging current is a minimum current.

In one aspect of the present disclosure, the first local grid voltage is greater than the nominal grid voltage, the first charging mode is the maximum charging mode, and the first charging current is a maximum current.

In one aspect of the present disclosure, the first state of charge is greater than 80%, the first battery voltage is less than a maximum battery voltage, the first charging mode is the constant charging mode, and the first charging current is a pre-determined charging current value.

In one aspect of the present disclosure, the first state of charge is 100%, the first charging mode is the stop charging mode, and the first charging current is OA.

In one aspect of the present disclosure, the charging current is controlled by a Direct-Quadrature frame for an autonomous charging control.

In another exemplary embodiment of the present disclosure, a system for controlling charging of a plurality of electric vehicles electrically connected to a power distribution system is disclosed. The system includes a plurality of nodes having an upstream node and a downstream node connected to the power distribution system. Each node of the plurality of nodes has a sensor configured to measure a local voltage and a local current and is configured to charge the plurality of electric vehicles.

The system includes a microcontroller connected to the plurality of nodes configured to execute a program instruction. The program instruction includes determining a voltage change tolerance based on a first local grid voltage of the power distribution system at a first time point and a second local grid voltage of the power distribution system at a second time point. The first time point is prior to the second time point, and the first and second local grid voltage is measured within a first range from a first electric vehicle of the plurality of electric vehicles located at the upstream node in the power distribution system. The program instruction further includes measuring a third local grid voltage of the power distribution system at a third time point, a fourth local grid voltage of the power distribution system at a fourth time point, a first state of charge of the first electric vehicle of the plurality of electric vehicles at the fourth time point, and a first battery voltage of the first electric vehicle of the plurality of electric vehicles at the fourth time point. The third time point is prior to the fourth time point and after the second time point, and the third and fourth local grid voltages are measured within the first range of the first electric vehicle of the plurality of electric vehicles. The program instruction further includes comparing the first battery voltage and a first maximum battery voltage to determine a first charging mode of the first electric vehicle of the plurality of electric vehicles and determining a first charging current of the first electric vehicle of the plurality of electric vehicles based on the third and fourth local grid voltages, the first state of charge, and the first battery voltage. The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 depicts a centralized control system for managing electric vehicle (EV) charging within a distribution network, according to certain embodiments.

FIG. 2 illustrates a schematic of an autonomous electric vehicle (EV) charging control system configured to manage the charging of a plurality of EVs within a power distribution system, according to certain embodiments.

FIG. 3 depicts a graphical presentation of constant current (CC) and constant voltage (CV) charging of a battery, according to certain embodiments.

FIG. 4 illustrates a flow of a method for controlling charging of a plurality of electric vehicles, according to certain embodiments.

FIG. 5 illustrates a schematic of an EV charging system, according to certain embodiments.

FIG. 6A illustrates a single line diagram of a grid connected to the EV battery, according to certain embodiments.

FIG. 6B illustrates the reference current generation I_{d-ref} process, according to certain embodiments.

FIG. 6C depicts the grid current control strategy, according to certain embodiments.

FIG. 7 demonstrates the performance of the real current controller for two separate converters engaged in battery charging for electric vehicles, EV-1 and EV-2, according to certain embodiments.

FIG. 8 is a graphical representation of the reactive current controller performance, according to certain embodiments.

FIG. 9 presents the grid voltage and current waveforms during the charging operation of the Electric Vehicle (EV) battery set-1, according to certain embodiments.

FIG. 10 displays the grid voltage and current waveforms during the charging operation of EV battery set-2, according to certain embodiments.

FIG. 11 illustrates the autonomous charging control of an EV battery at the Upstream node, according to certain embodiments.

FIG. 12 depicts the autonomous charging control of an EV battery at the Downstream node, according to certain embodiments.

FIG. 13 presents the performance of a charging current controller without voltage change tolerance, according to certain embodiments.

FIG. 14 provides a comparison of voltage and current waveforms at Upstream and Downstream nodes, according to certain embodiments.

FIG. 15, illustrates an experimental setup utilized for validating the autonomous decentralized charge controller, according to certain embodiments.

FIG. 16 displays the measured direct-axis (d-axis) current waveforms for two battery units during the charging process, according to certain embodiments.

FIG. 17 is a graphical representation of the measured current and voltage waveforms for the same battery units while being charged, according to certain embodiments.

FIG. 18 depicts the autonomous charging control of an EV battery at the Upstream node, according to certain embodiments.

FIG. 19 depicts the autonomous charging control of an EV battery at the Upstream node, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a system, device, and method configured for electric vehicle (EV) charging management especially in residential distribution systems, employing an autonomous controller that operates independently of centralized communication. The controller adapts the charging rates of EVs to enhance voltage stability across the distribution network and incorporates a proportional and weight-based algorithm that adjusts charging activities based on local voltage conditions, effectively managing the distribution of large charging currents and mitigating issues such as overloading and undervoltage.

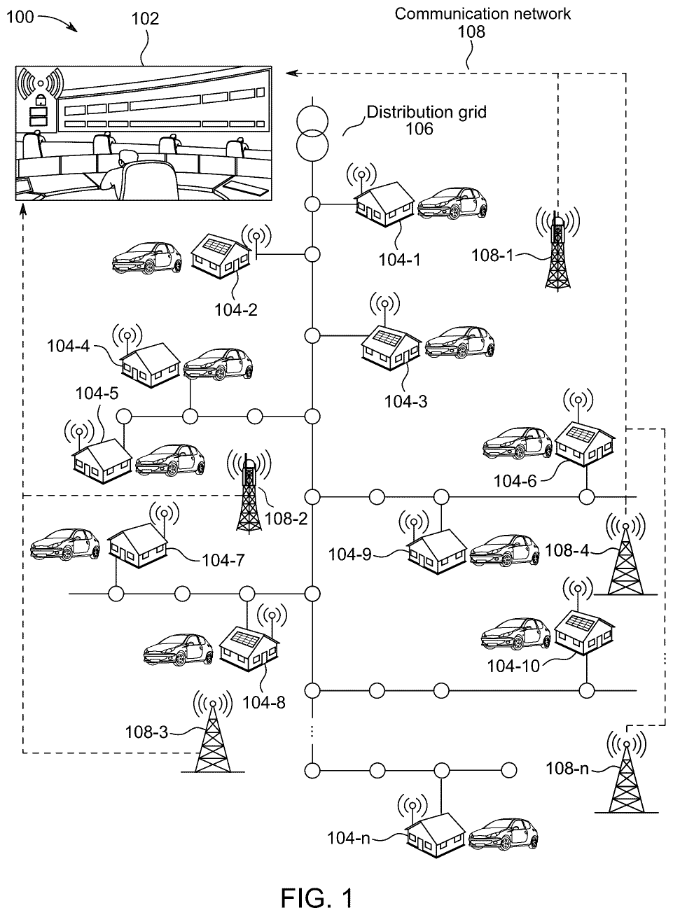

FIG. 1 depicts a centralized control system for managing electric vehicle (EV) charging within a distribution network, in accordance with certain embodiments. The centralized control system, alternatively referenced to as the system 100 hereinafter, is implemented to facilitate the distribution and management of electrical power to a network of charging stations. The system 100 includes a central controller 102 connected to a plurality of charging hubs 104 through a communication network 108 and a distribution grid 106.

The plurality of charging hubs include one or more charging hubs (104-1, 104-2, 104-3, 104-4, 104-5, 104-6, 104-7, 104-8, 104-9, 104-10 . . . 104-n), individually or combinedly referred to as the charging hubs 104, placed within the power distribution networks. The charging hubs 104 are essentially stations with multiple charging points for electric vehicles.

Data communication between the charging hubs 104 and the central controller 102 allows for real-time data exchange and operational control. The plurality of charging hubs 104, depicted as a series of interconnected nodes, are equipped with one or more charging ports to facilitate the connection and charging of EVs. The plurality of charging hubs 104 communicate their status, such as availability, current load, and anticipated demand, to the central controller 102. The communication allows for dynamic load balancing, improved energy distribution, and advanced scheduling to accommodate the charging requirements of registered EVs while maintaining the integrity of the electrical distribution grid.

The communication network may include, but is not limited to, wireless fidelity (Wi-Fi) networks, cellular networks, fiber-optic connections, or any other form of digital communication capable of high-bandwidth data transmission. The communication network facilitates the rapid exchange of information and commands between the central controller 102 and the charging hubs 104, thereby ensuring real-time management and synchronization of EV charging processes.

The data communication between the central controller 102 and the plurality of charging hubs 104 is facilitated through the communication network having a plurality of transceiver antennas (108-1, 108-2, 108-3, 108-4 . . . , 108-n), combinedly denoted by reference numeral 108. Each of the plurality of the antennas (108-1, 108-2, 108-3, 108-4 . . . , 108-n) is communicatively coupled to the central controller 102 and is implemented to transmit and receive communication signals from the central controller 102. Further, each of the plurality of the antennas (108-1, 108-2, 108-3, 108-4 . . . , 108-n) is configured to communicate with one or more charging hubs 104. Thereby, the communication network 108 facilitates the data communication between the charging hubs 104 and the central controller 102.

The system 100 includes a central controller 102. The central controller 102 is a computing device configured to receive, process, and analyse data from a multitude of entities within the EV ecosystem. The central controller 102 has one or more processor(s) and a memory coupled to the processor to store operational instructions, where execution of the instructions causes the one or more processor(s) to receive data inputs from various system nodes which may include EV charging hubs, grid operators, power generation sources, and user interface portals.

The one or more processor(s) of the central controller 102 processes the gathered data to maintain a balanced network load, ensure the stability of power distribution, and prevent infrastructure overload. The one or more processor(s) further processes real-time variables, such as EV battery levels, grid demand, charging station availability, and user requirements. Subsequently, the central controller 102 disseminates reference signals or commands to the connected charging hubs 104, dictating the charging operations to align with the overall management strategy.

The integration of the plurality of charging hubs 104 into the distribution grid provides energy efficiency, reliability, and user convenience. By implementing methods, such as an advanced metering infrastructure (AMI) and grid automation, the central controller 102 can execute decisions that improve charging schedules based on a multitude of factors including user charging preferences, grid load conditions, and real-time electricity pricing.

The central controller 102 is operated by a centralized control method for managing electric vehicle (EV) charging and integrating renewable energy sources, such as solar and wind power, into the power grid. In accordance with the centralized control method, the central controller 102 gathers data on EV status, grid conditions, and renewable energy generation, and then, utilizes the gathered data to orchestrate EV charging and discharging behaviour in a way that improves grid stability and minimizes negative impacts like voltage fluctuations and power losses.

The system 100 is operated by a control method. Several centralized control methods have been implemented for managing electric vehicle (EV) charging and integrating renewable energy sources. Such methods, described in the background section of the present disclosure, are susceptible to communication disruptions, have complex infrastructure, and require significant infrastructure investment. To overcome these challenges, an autonomous decentralized charge control method and system is disclosed.

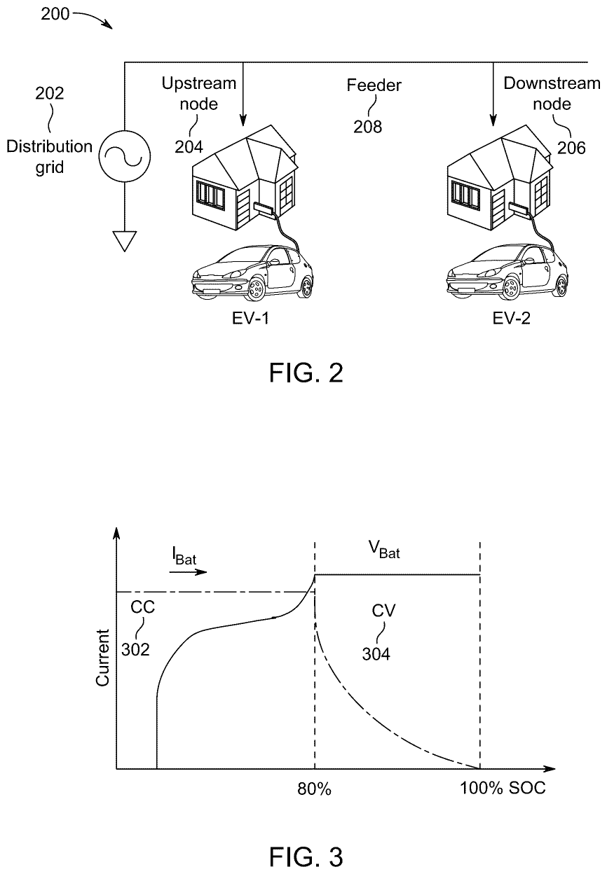

FIG. 2 illustrates a schematic of an autonomous electric vehicle (EV) charging control system configured to manage the charging of a plurality of EVs within a power distribution system, in accordance with certain embodiments. In an exemplary implementation of the system 200 incorporates two sets of EV batteries, where first set is for EV-1 and second set is for EV-2. Each set is connected to a distribution grid 202. The first set is positioned proximate to a power source and the second set is situated at certain distance from the power source. The first set 204 and the second set 206 within the power distribution system are respectively identified as the upstream node 204 and the downstream node 206.

FIG. 2 in view of FIG. 1 may incorporate multiple time points connected in the grid at different distances. Each of the upstream or downstream nodes may have multiple time points. For example, a first time point, a second time point, a third time point, and so on. Each point is distributed with a corresponding grid voltage. For example, at the first time point, a first local grid voltage can be measured. The upstream node and the downstream node in the power distribution system exclude a communication system for a decentralized charging control.

The upstream node 204 and a downstream node 206 are connected to the power distribution system, and each node has at least one sensor configured to measure at least one parameter, such as a local voltage and a local current. The node (204, 206) is configured to charge the plurality of electric vehicles. The upstream node 204 typically refers to a charging node on the grid connected closer to the power grid or a power source. Electricity flows from the upstream node towards the loads. The downstream node 206 refers to a charging node on the grid connected at further distance as compared to the upstream node 204. Electricity flows from the upstream node and reaches the downstream node before reaching the loads.

A feeder 208 serves as a conduit for electrical power between the upstream node 204 and the downstream node 206, facilitating the flow of electricity within the system. The downstream node 206, established further from the source point, constitutes the second point of connection and is configured to receive power from the feeder 208, thus serving as a link to the EV batteries positioned remotely from the source point.

As depicted in the system 200, both controlled and non-controllable loads may be present in a distribution transformer. The charging control of EV batteries of the present embodiment are the controllable loads, and are autonomously managed based on local grid voltage conditions. The system 200 is configured to autonomously adjust the charging current of the EV batteries in response to the local voltage levels to resolve low voltage issues in the power distribution system. To charge the batteries, the EV charger transforms the grid's AC electricity into a regulated DC current. As a result, the grid views the EV as a current source. In scenarios, where the bus voltage is close to the minimum threshold voltage (0.95 pu), the EV charger should not be increasing the charging.

The autonomous control is configured to modulate the charging rate by setting the charging current to a minimum when the local grid voltage approaches a minimum threshold voltage, and to a maximum when the grid voltage is at or near nominal value. The charging current is variably adjusted when the grid voltage lies between the nominal and minimum threshold voltages.

The charging system dynamically adjusts the charging current in correlation with the grid voltage. When the grid voltage is at its lower limit, the system minimizes the charging current to prevent overloading. Conversely, when the grid voltage is at its standard level, the system allows for maximum charging current. For grid voltages between these two states, the charging current is proportionally regulated. This method, however, leads to equal distribution issues among EVs due to their varying proximity to the area of strong grid voltage. The goal is to ensure equitable charging, so no EV charges disproportionately faster or slower because of its location in the grid. EVs at lower voltage downstream positions should not experience significantly reduced charging rates compared to those at higher voltage upstream positions. To address this, the system applies an automatic adjustment, adding a compensatory weight to the chargers of EVs at downstream nodes, ensuring that their charging current is not diminished to the same extent as might be caused by voltage reductions in a straightforward proportional control scenario.

The system 200, as depicted in FIG. 2, is implemented by a control method for controlling charging of a plurality of electric vehicles electrically connected to a power distribution system. In one aspect, according to the control method, the system 200 determines a voltage change tolerance based on a first local grid voltage at a first time point and a second local grid voltage at a second time point. The first time point is an upstream node 204, located prior to the second time point which is a downstream node 206. The first and second local grid voltages are measured within a first range from a first electric vehicle of the plurality of electric vehicles located at the upstream node in the power distribution system.

In another aspect, the system 200 measures the local grid voltage at multiple points. The system 200, in one example, measures a third local grid voltage at a third time point, a fourth local grid voltage of the power distribution system at a fourth time point, a first state of charge (SOC) of the first electric vehicle of the plurality of electric vehicles at the fourth time point, and a first battery voltage of the first electric vehicle of the plurality of electric vehicles at the fourth time point. The SOC measurement is described in detail with reference to FIG. 3. According to the locations of the time points, the third time point is prior to the fourth time point and after the second time point, and the third and fourth local grid voltages are measured within the first range of the first electric vehicle of the plurality of electric vehicles.

The system 200 compares the first battery voltage and a first maximum battery voltage to determine a first charging mode of the first electric vehicle of the plurality of electric vehicles. Thereafter, the system 200 determines a first charging current of the first electric vehicle of the plurality of electric vehicles based on the third and fourth local grid voltages, the first state of charge, and the first battery voltage.

In one aspect, the first charging mode is selected from the group consisting of a minimum charging mode, a maximum charging mode, a variable charging mode, a constant charging mode, and a stop charging mode. The method steps of measuring the third local grid voltage, the comparing, and the determining are repeated until the first charging mode is changed to the minimum charging mode, the maximum charging mode, the constant charging mode, or the stop charging mode.

When the first charging mode is the minimum charging mode, the first local grid voltage is less than or equal to a threshold voltage, and the first charging current is a minimum current.

When the first local grid voltage is greater than the nominal grid voltage, the first charging mode is the maximum charging mode, and the first charging current is a maximum current.

When the first state of charge is greater than 80%, the first battery voltage is less than a maximum battery voltage, the first charging mode is the constant charging mode, and the first charging current is a pre-determined charging current value.

When the first state of charge is 100%, the first charging mode is the stop charging mode, and the first charging current is OA.

When the first charging mode is the variable charging mode, typical proportional based first charging current is determined in accordance with:

EV charging current is given by:

$${I}_{EV} = {I}_{m ax} - {k}_{p} ( {V}_{r} - {V}_{k} ( t ) ) , \qquad ( 1 )$$

here, Iₘₐₓ is the maximum charging current at nominal grid voltage, Vᵣ is the nominal grid voltage (1 pu), and Vₖ(t) is the measured grid voltage at time t.

Although this control strategy automatically reduces charging current to improve the grid voltage profile, downstream EV encounters higher reduction of charging current according to (1).

Therefore, this work automatically adds weight to the EV charger connected downstream node that does not reduce the same amount charging current resulting from the proportional control approach with the node voltage reduction. It is given by (2) and (3).

### Proportional and Weight-Based EV Charging Current,

When the first charging mode is the variable charging mode, proportional and weight-based first charging current is determined in accordance with:

$${I}_{EV} = {I}_{m ax} - {k}_{p} min ( {ΔV}_{m ax} , ( {V}_{r} - {V}_{k} ( t ) ) + {μ}_{k} ( t ) \qquad ( 2 )$$

wherein I_{EV} is the charging current, Iₘₐₓ a maximum charging current, kₚ is a first scaling factor, ΔVₘₐₓ is maximum voltage deviation from a nominal grid voltage, Vᵣ is the nominal grid voltage, Vₖ(t) is the second local grid voltage, and μₖ(t) is a weight,

$${μ}_{k} ( t ) = min ( {μ}_{m ax} , b ( {V}_{r} - {V}_{k} ( t ) ) \qquad ( 3 )$$

Here, kₚ and b are constant or scaling factor to convert voltage to suitable current, ΔVₘₐₓ is maximum voltage deviation from the nominal grid voltage, μₘₐₓ maximum weight that can be added against the proportional reduction. However, this weight is also function of voltage difference that means higher voltage difference yields higher weight whereas lower voltage difference yields lower weight.

In one aspect of the present embodiment, the weight is determined based on the third and fourth local grid voltages of the first electric vehicle of the plurality of electric vehicles measured within the first range from the first electric vehicle of the plurality of electric vehicles, a fifth local grid voltage of the power distribution system at the third time point, a sixth local grid voltage of the power distribution system at the fourth time point, a second state of charge of a second electric vehicle of the plurality of electric vehicles at the fourth time point, and second battery voltage of the second electric vehicle of the plurality of electric vehicles at the fourth time point. Where, the fifth and sixth local grid voltages are measured within a second range from the second electric vehicle of the plurality of electric vehicles. Where the second electric vehicle is located at a downstream node in the power distribution system.

FIG. 3 depicts a graphical presentation of constant current (CC) and constant voltage (CV) charging of a battery, in accordance with certain embodiments. In one aspect of the present disclosure, the charging method involves charging the battery at a constant current value, which is particularly effective in the initial stage of charging when the battery voltage is low. The charging process continues at this constant current until the battery voltage reaches a set level. Once the set voltage level is reached during the CC mode, the charging process switches to CV mode. In this mode, the voltage across the battery is held constant. As the battery reaches its capacity, the current will gradually decrease while the voltage remains steady. The charging method is essential for fully charging the battery while preventing overcharging.

For the longevity of a battery's service life, it is typically recommended to utilize a dual-mode charging strategy that employs both constant current (CC) and constant voltage (CV) methods. The CC charging cycle is depicted by curve 302. The CV charging cycle is depicted by curve 304.

During the CC phase, the battery is charged at a fixed current until it reaches its maximum terminal voltage. The specific constant current value is dictated by the battery's capacity (C), commonly ranging between 0.5 C to 0.8 C, allowing for a swift accumulation of charge, often referred to as the Fast Charging State.

Transitioning from the CC mode, once the battery achieves an 80% state of charge (SOC), the CV mode commences, maintaining the battery voltage at a fixed level equal to the battery's maximum voltage. The charging current tapers off as the SOC approaches full capacity. The CV phase ensures the completion of the battery charge without overcharging, thereby preserving battery integrity.

For the successful realization of CC and CV method, the information of state of charge (SOC) of battery is needed. The following relation defines the state of charge of the battery.

$$SOC = {SOC}_{0} - \frac{1}{3600 A H} {\int }_{0}^{t} {I}_{Battery} dt \qquad ( 4 )$$

Where, SOC₀ is the initial state of charge, AH is the nominal ampere-hour of the battery, and I_{Battery} is the battery charging/discharging current.

The coulomb counting method, also known as the ampere-hour counting and current integration approach, is the method used to calculate the SOC in equation (4). The method is based on numerically integrated battery current readings acquired over a defined operational period to establish SOC values. The coulomb counting method calculates the remaining capacity by cumulatively summing the charge that enters and exits the battery. The precision of this method is dependent upon the acquisition of highly accurate battery current measurements and an accurate initial SOC estimation.

The SOC can be computed by integrating the charging and discharging currents experienced during operation, given a predetermined capacity value that can be either stored or initially estimated based on the prevailing operating conditions. The incorporation of the open-circuit voltage (OCV) approach significantly enhances the accuracy, or calibration, of the coulomb counting method. The method employs an OCV measurement to determine the initial SOC, followed by a dynamic calculation of the SOC using the aforementioned coulomb counting method.

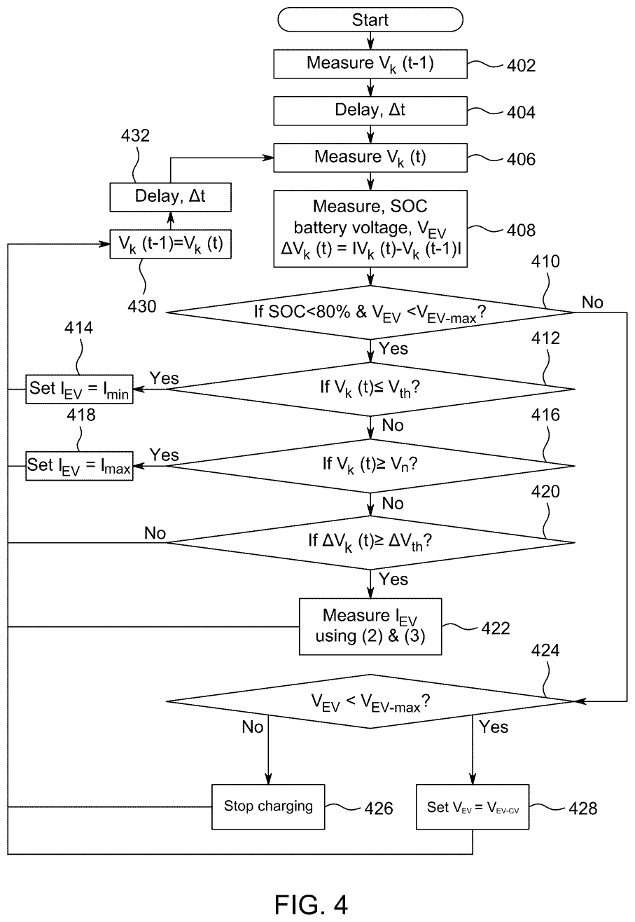

FIG. 4 illustrates a flow of a method for controlling charging of a plurality of electric vehicles, in accordance with certain embodiments. FIG. 4 illustrates a schematic representation of the control algorithm developed for addressing under-voltage issues, optimizing the EV battery charging process, and maintaining fairness in charging current regardless of an EV's location within the distribution grid. The depicted flow operates by measuring grid voltage at two points. First grid voltage Vₖ(t−1) is measured at step 402. Second measurement is delayed in time separated by an interval Δt at step 404. Second grid voltage Vₖ(t) is measured at step 406. The measurement derives a minimum voltage change tolerance ΔVₜₕ for regulating the charging current update cycle. In some embodiments, the minimum voltage change tolerance ΔVₜₕ is the difference between the first grid voltage Vₖ(t−1) and the second grid voltage Vₖ(t). The minimum voltage change tolerance ΔVₜₕ is calculated to prevent the back-and-forth condition of charging current. If the charging current is increased, then the grid voltage may decrease, which further decreases the charging current and increases the grid voltage. That is, charging current is not updated until a certain amount of voltage change, minimum voltage change tolerance ΔVₜₕ, is observed.

In such framework, the system refrains from modifying the charging current unless there is a detectable change in grid voltage that exceeds the ΔVₜₕ threshold. It integrates multiple parameters, including the state of charge (SOC) of the battery, the battery voltage, and changes in the grid voltage to assess the appropriate charging condition. The SOC of the battery is measure at step 408. Step 410 compares, if the SOC fall below 80% and the battery voltage remain less than the maximum battery voltage, the method proceeds to the subsequent verification step.

If the grid voltage is equal to or less than a pre-defined threshold voltage (Vₜₕ), step 412, the charging current is minimized to prevent further undervoltage conditions, step 414. Conversely, if the grid voltage exceeds or equals the nominal voltage, step 416, the charging current is maximized, step 418. In instances where neither of these conditions is met but the change in grid voltage surpasses ΔVₜₕ, step 420, the flow calculates the appropriate charging current using predefined equations (2) and (3), step 422.

Additionally, the method transitions to a constant voltage (CV) charging mode once the SOC exceeds 80% while the battery voltage remains below the maximum charging voltage, step 424. Upon the battery reaching full charge, the flow halts the charging process to prevent overcharging, step 426. If the battery is not fully charged, then V_{EV} is set equal to V_{EV-CV}, step 428.

When the first grid voltage is equal to the second grid voltage, step 430, delay of Δt is introduced at step 432. The method flow is repeated from step 406.

This control method ensures that the charging mechanism is responsive to both the immediate electrical conditions of the grid and the longer-term charging needs of the battery, thereby ensuring system stability, battery integrity, and equitable energy distribution among electric vehicles connected to the grid.

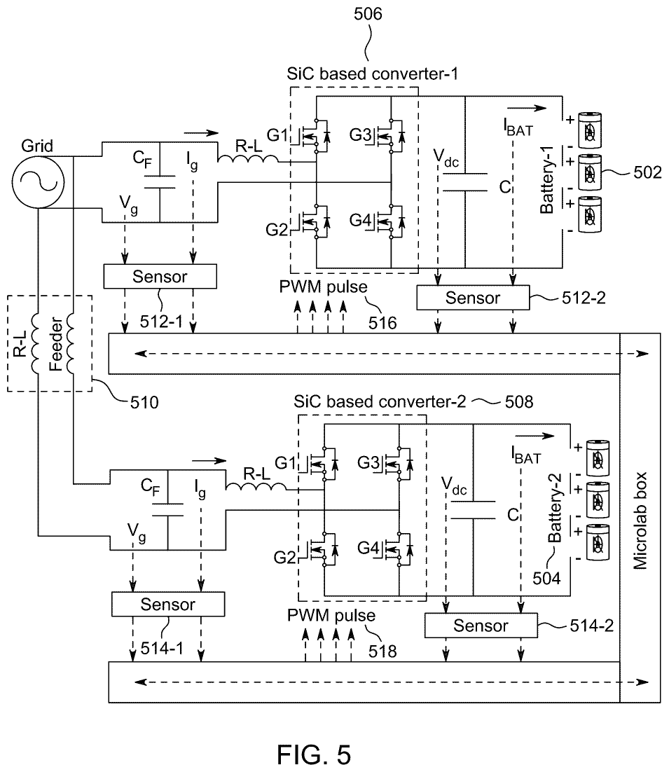

FIG. 5 illustrates a schematic of an EV charging system 500, in accordance with certain embodiments. The EV charging system 500 is configured to charge two sets of EV batteries through a single-stage full-bridge AC-DC converter, thereby streamlining the charging process by eliminating the need for separate AC/DC and DC/DC conversion stages. Each set of EV batteries is connected in series with a feeder impedance, which acts as a buffer to moderate the delivery of voltage and current, ensuring that charging is executed within the electrical thresholds of the EV batteries.

As shown in the FIG. 5, battery-1 502 and battery-2 504 are connected to a Silicon Carbide (SiC) based single-stage full bridge AC-DC converter-1 506 and a SiC based single-stage full bridge AC-DC converter-2 508, respectively. The SiC-based single-stage full-bridge AC-DC converter is a type of power converter designed to convert alternating current (AC) from the mains grid directly into direct current (DC) at a desired voltage level, all in one stage. Through the converters (506 and 508), the battery-1 502 and the battery-2 504 are connected to the feeder impendence 510 which is incorporated into the system to control and stabilize the current and voltage from the grid to the converter, thus protecting the batteries from potential surges or spikes in power supply. A first set of sensors (512-1, 512-2) of the battery-1 502 and a second set of sensors (514-1, 514-2) of the battery-2 504 are configured for monitoring grid voltage and current, as well as battery voltage and current. The sensors (512-1, 512-2, 514-1, 514-2) provide real-time data to the controller, ensuring the charging process is dynamically adjusted according to the needs of the EV batteries. First PWM pulse 516 and second PWM pulse 518 are provided, where PWM modulates the width of the gate pulses in response to the system's requirements, adjusting the charging current with high precision to match the charging needs of the respective batteries at any given moment.

The depicted grid supplies alternating current (AC) voltage and current, which are fed to the controller along with the battery voltage and battery current. The controller is programmed to generate gate pulses that regulate the required charging current for the EV batteries. The converter's control logic is developed in the direct-quadrature (d_{q}) frame rather than the stationary frame, allowing for the synchronization of the control actions with the grid's oscillations. Thus, the charging current is controlled by the Direct-Quadrature frame for an autonomous charging control, in one aspect.

In the operation of the system, stationary signals from the grid voltage and grid current are transformed into d_{q} signals based on the grid angle. Subsequent control actions are executed within this d_{q} frame, taking advantage of the frame's ability to simplify the dynamics of the current controller for the converter. The steady-state behaviour of the converter's current controller, essential for maintaining stable charging conditions, is governed by specified equations in the d_{q} frame.

The control mechanism described for the first converter is also applicable to a second converter, and to multiple converters, if utilized within the same system. Such configuration ensures that charging control is uniformly maintained across all connected EV battery sets, facilitating efficient energy conversion and battery charging.

$$L \frac{{di}_{d}}{dt} + {Ri}_{d} = L {ω}_{0} {i}_{q} + {V}_{dC} - {V}_{d} \qquad ( 5 )$$

$$L \frac{{di}_{q}}{dt} + {Ri}_{q} = - L {ω}_{0} {i}_{d} + {V}_{qC} - {V}_{q} \qquad ( 6 )$$

The d_{q} components of grid voltage (V_{g}) are denoted V_{d} and V_{q}.

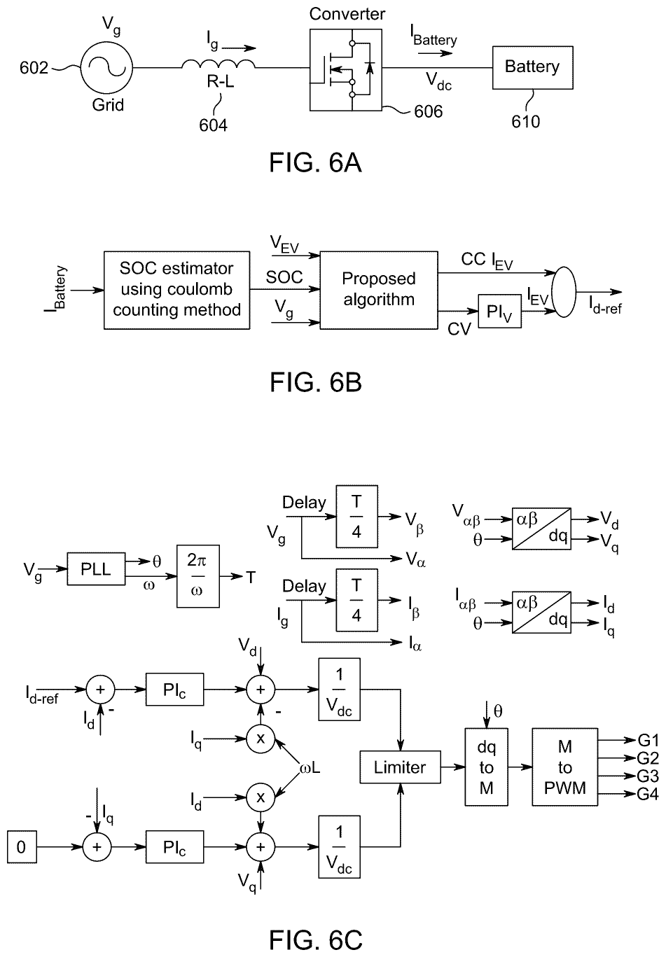

FIG. 6A-FIG. 6C provide a detailed representation of current control in the d_{q} frame for a grid-connected system. FIG. 6A illustrates a single line diagram of a grid connected to the EV battery. The line diagram shows the d_{q} components of grid current Ig, denoted as i_{d} and i_{q}. Grid 602 supplies grid voltage V_{g} through RL circuit 604 to a converter 608. From the converter 608, matter current I_{BATTERY} is provided to the battery 610. In the RL circuit 604, the reactor's inductance and resistance are represented by L and R, respectively. V_{dC} and VqC are the d_{q} components of the converter output.

FIG. 6B illustrates the reference current generation I_{d-ref} process. The reference charging current is generated either directly from the Constant Current (CC) mode or after the voltage control loop from the Constant Voltage (CV) mode. A SOC estimator 612 measure SOC using Coulomb counting method. A computation algorithmic unit 614 compute EV voltage V_{EV}, SOC, and grid voltage V_{g}. CV output is processed through a Proportional-Integral (PI) controller 616.

By processing current corresponding to CC cycle and CV cycles, the reference current generation I_{d-ref} is generated.

FIG. 6C depicts the grid current control strategy. The grid current control strategy employs a quadrature transport delay block (T/4) to derive a 90-degree phase-shifted signal for the single-phase signal, as opposed to the method used for a three-phase grid. The αβ frame components are transformed into the d_{q} rotating reference frame using the Park transform, with the PLL-derived grid angle (θ) providing the reference angle for the rotating frame. The reference real current (i_{d}) is used to control the charging and discharging current for batteries, a positive i_{d} indicates power flow from grid to battery, while a negative i_{d} indicates power flow from battery to grid.

The current reference error is processed through a Proportional-Integral (PI) controller. This output, along with the feedforward and decoupling term, produces the V_{d} and V_{q} components. These components are then converted into a modulating signal, which is used to generate gate pulses for the full bridge converter.

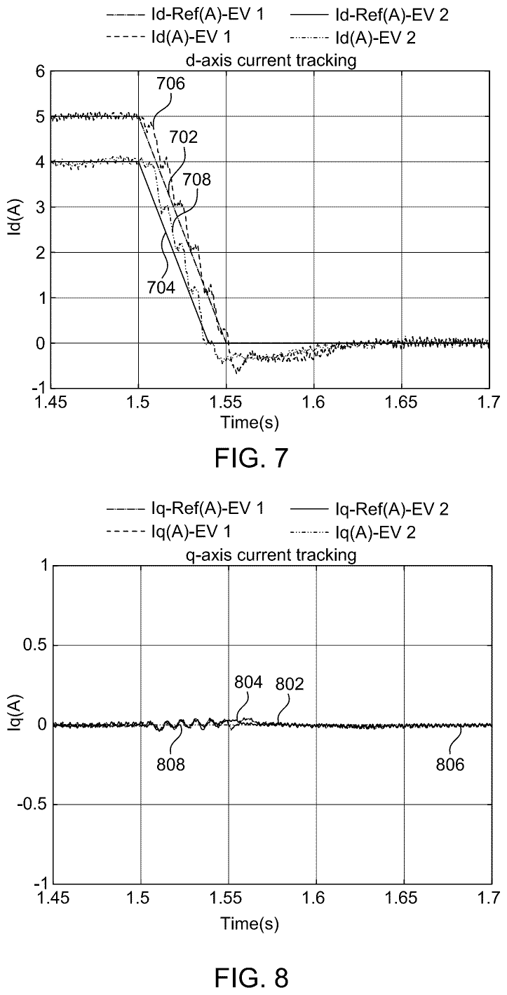

FIG. 7 demonstrates the performance of the real current controller for two separate converters engaged in battery charging for electric vehicles, EV-1 and EV-2. The d-axis current, or real current command (id-Ref) is initially set to 5 amperes for EV-1, denoted by curve 702 and real current command (id-Ref) is initially set to 4 amperes for EV-2 denoted by curve 704 to facilitate the grid to battery power flow. Subsequently, this command is reduced to 0 amperes as shown in the figure. The graph depicts the actual real current (i_{d}) for both EVs, indicated by curve 706 for EV-1 and curve 708 for EV-2. Despite a slight overshoot compared to the reference current, the actual current adheres closely to the commanded values. This behaviour illustrates the current controller's capability to handle grid to battery power transfer effectively.

FIG. 8 is a graphical representation of the reactive current controller performance, tracking the q-axis current, or reactive current for both electric vehicle converters. For both the reactive reference current (i_{q-Ref}) for EV-1, denoted by curve 802, and the reactive reference current (i_{q-Ref}) for EV-2, denoted by curve 804, is set to 0 amperes, as the primary requirement is the reception of real power from the AC grid at unity power factor. The actual reactive current (i_{q}), represented by curve 806 for EV-1 and curve 808 for EV-2, closely follows its corresponding reference current. The graph, thus, demonstrates the controller's precision in maintaining a zero reactive current command, which ensures the transfer of real power only, thereby optimizing the charging process and the power flow from the grid to the battery. The stability of the i_{q} near zero confirms the system's effectiveness in managing reactive power within the grid-connected system.

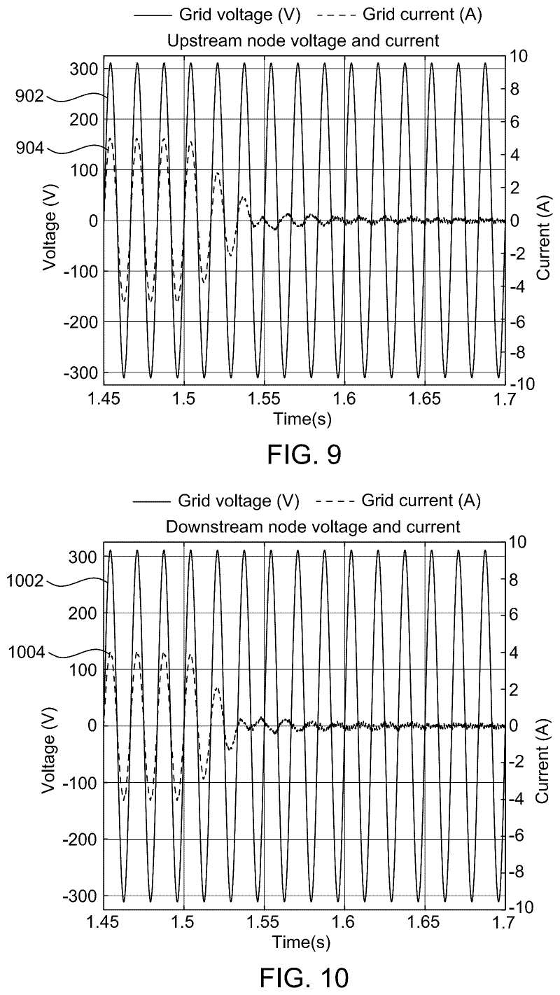

FIG. 9 presents the grid voltage and current waveforms during the charging operation of the Electric Vehicle (EV) battery set-1. The grid voltage is depicted by curve 902, and the grid current is depicted by curve 904. The figure displays the synchronization of current and voltage, which implies that the EV battery is charged at unity power factor. The phase angle between the voltage and current waveforms is minimized, indicating efficient energy transfer with minimal reactive power. The unity power factor is desirable as it implies that the power drawn from the grid is being used effectively for charging the battery, without leading to unnecessary power grid stress.

FIG. 10 displays the grid voltage and current waveforms during the charging operation of EV battery set-2, in accordance with certain embodiments. The grid voltage is depicted by curve 1002, and the grid current is depicted by curve 1004. As with FIG. 9, the depiction demonstrated the charging process occurring at a unity power factor, characterized by the alignment of current and voltage waveforms in phase. This again indicates that the system is effectively converting all the power drawn from the grid into useful charging energy for the battery, with negligible reactive power component.

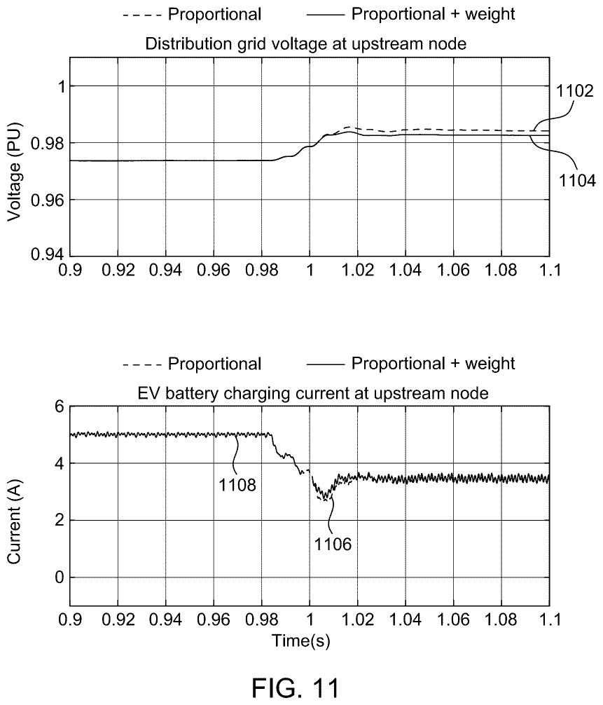

FIG. 11 illustrates the autonomous charging control of an EV battery at the Upstream node, in accordance with certain embodiments. It demonstrates two control techniques for the EV battery charging current under conditions where the grid voltage and current are in phase, and the State of Charge (SOC) for the EV battery is below 80%. The node voltage is recorded at 0.975 per unit (pu). The graph displays two implementations, one with proportional-based control, where the EV charging current is reduced proportionally with the node voltage decrease from the nominal value of 1 pu, the other applies a proportional plus weight-based control, which incorporates an additional weight to mitigate the reduction of the charging current. Curve 1102 depicts voltage (pu) obtained by the proportional control method and curve 1104 depicts voltage (pu) obtained by the proportional plus weight-based control method. Curve 1106 depicts current (A) obtained by the proportional control method and curve 1108 depicts current (A) obtained by the proportional plus weight-based control method. The EV charging current at the Upstream node is shown to reduce from 5 A to 3.8 A with proportional control, and to 3.85 A with proportional plus weight control.

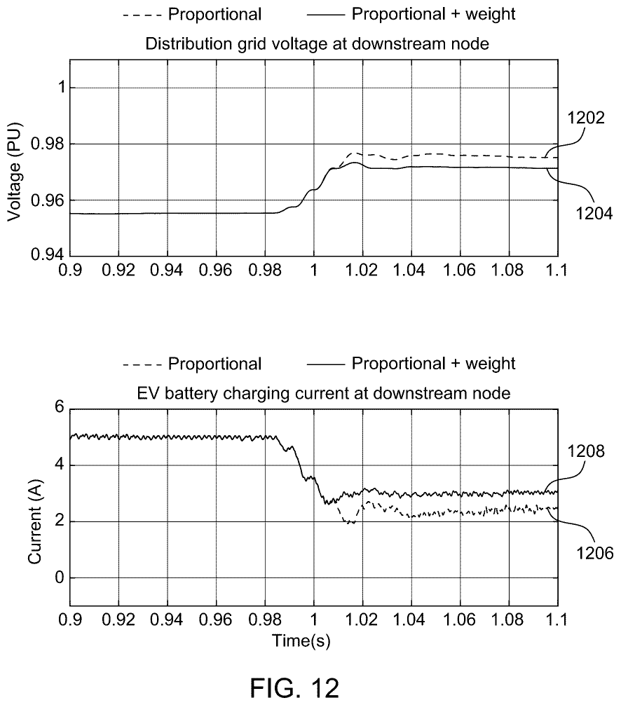

FIG. 12 depicts the autonomous charging control of an EV battery at the Downstream node, also showing the performance of the same two control techniques. Curve 1202 depicts voltage (pu) obtained by the proportional control method and curve 1204 depicts voltage (pu) obtained by the proportional plus weight-based control method. Curve 1206 depicts current (A) obtained by the proportional control method and curve 1208 depicts current (A) obtained by the proportional plus weight-based control method.

The Downstream node voltage is observed at 0.957 pu. With the proportional-based control, the EV charging current reduces from 5 A to 2.2 A. However, when the proportional plus weight-based control is applied, the current reduction is less severe, decreasing from 5 A to 3 A, indicating a less negative impact on the EV connected at the Downstream node.

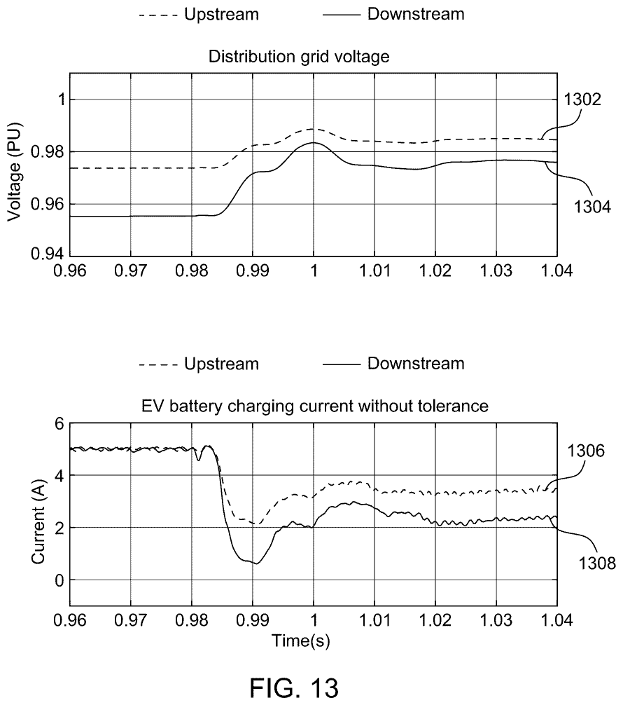

FIG. 13 presents the performance of a charging current controller without voltage change tolerance, contrasting with the other figures where tolerance is included. Curve 1302 depicts voltage (pu) of an upstream node and curve 1304 depicts voltage (pu) of a downstream node. Curve 1306 depicts current (A) of the upstream node and curve 1308 depicts current (A) of the downstream node.

The graph illustrates an abrupt change in the charging current when the controller is activated, leading to a 40% overshoot that also impacts the voltage profile with an overshoot. The absence of tolerance in the control strategy results in a more dramatic reaction compared to the more gradual changes observed in FIGS. 11 and 12 with the proportional and proportional plus weight-based control strategies.

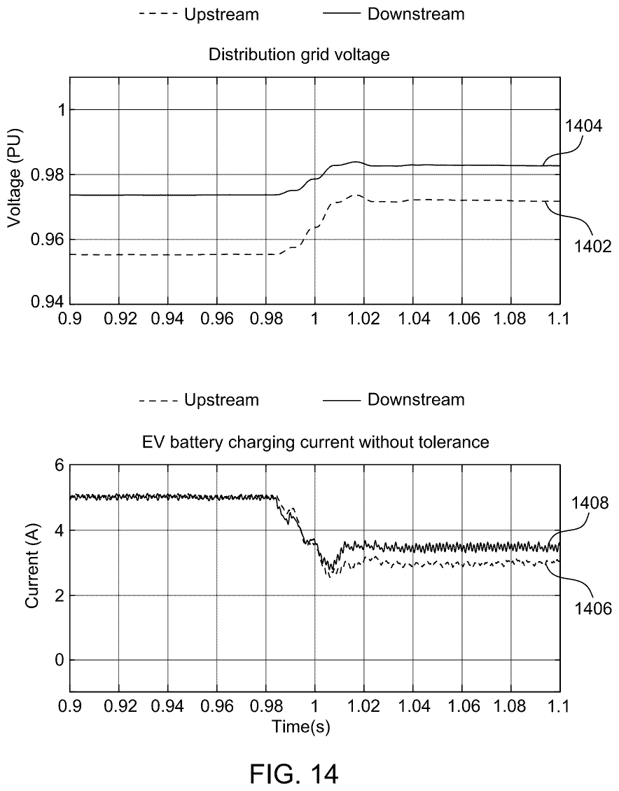

FIG. 14 provides a comparison of voltage and current waveforms at Upstream and Downstream nodes to evaluate the robustness of the EV battery charging current control strategy after the location of the generating source has been switched from the Upstream node to the Downstream node. As a result of this change, the Downstream node becomes the stronger node in terms of power supply capacity, while the Upstream node becomes weaker. Curve 1402 depicts voltage (pu) of an upstream node and curve 1404 depicts voltage (pu) of a downstream node. Curve 1406 depicts current (A) of the upstream node and curve 1408 depicts current (A) of the downstream node.

The graph displays the voltage at the Upstream and Downstream nodes over time, measured in per unit (pu). The graph further shows the corresponding charging currents for the EV connected at both nodes. These measurements are taken within a time frame denoted in seconds on the horizontal axis, while the voltage and current magnitudes are plotted on the vertical axis, also in per unit (pu) for voltage and in amperes (A) for current.

From the current waveform, it is observed that the charging current for the EV at the Downstream node decreases less than that at the Upstream node. The graph, thus, demonstrates the adaptability of the control strategy, despite the change in the power generation dynamics, the charging current control strategy effectively manages the varying conditions. The reduction in the charging current is indicative of the strategy's capacity to maintain stability and control despite the differing node conditions, thus illustrating its robustness.

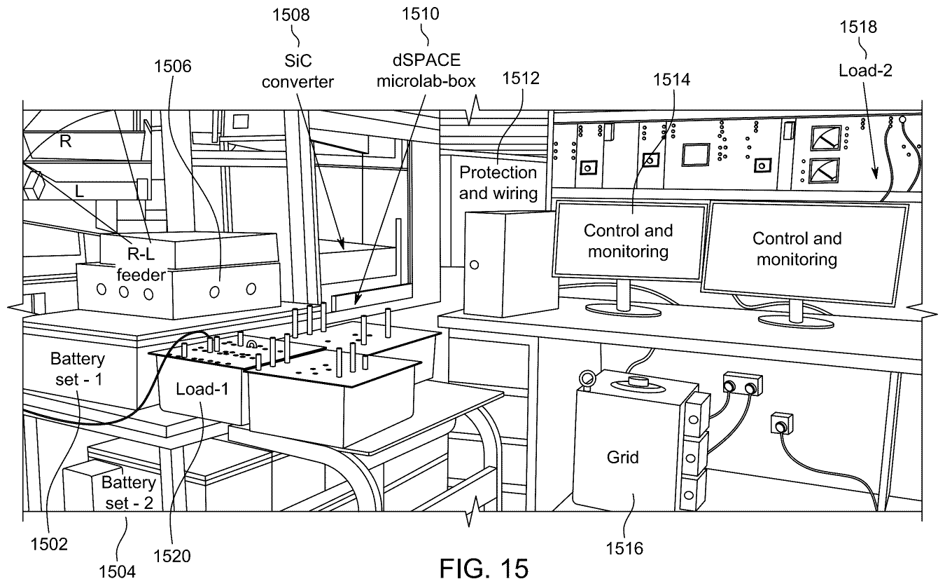

FIG. 15 illustrates an experimental setup utilized for validating the autonomous decentralized charge controller. The setup includes three lithium-ion battery packs connected in series to form a 160V DC link. To simulate an AC grid, a variable transformer is connected to the utility grid. An AC capacitor is employed to filter high-frequency harmonics at the grid connection points.

The control method is developed on the dSPACE MicroLab-Box platform 1510. LEM sensors are used to capture voltage and current signals. The setup features a battery-1 1502, a battery-2, an RL feeder 1506, and a single-phase converter based on Silicon Carbide (SiC) MOSFETs 1508, provided by Taraz Technologies, which is driven by Pulse Width Modulation (PWM) output. The dSPACE Control Desk software is used for real-time recording and display of currents and voltages.

Additionally, an inductor and resistor are incorporated to simulate a feeder. Another set of three battery packs are connected in series to establish a second DC link for a converter, which is also regulated using the same dSPACE MicroLab-Box 1510.

The set up shows the components, such as the battery sets (1502, 1504), the loads (1518, 1520), the SiC converter 1508, the dSPACE MicroLab-Box 1510, a protection and wiring unit 1512, a control and monitoring unit 1514, and the grid 1516. The entire setup is engineered to emulate the conditions for charging control in an EV battery system, allowing for the thorough testing and validation of the control strategies outlined in the disclosure.

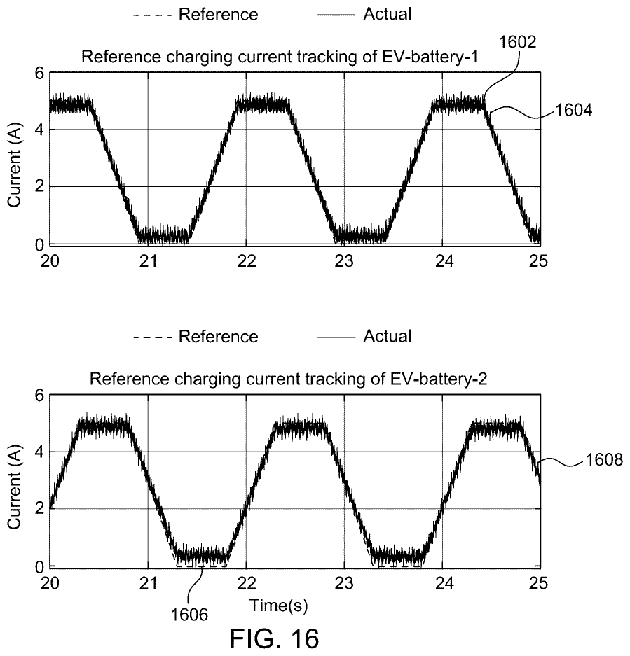

FIG. 16 displays the measured direct-axis (d-axis) current waveforms for two battery units during the charging process. Curve 1602 depicts reference current and curve 1604 depicts actual current of EV battery-1, respectively. Curve 1606 depicts reference current and curve 1608 depicts actual current of EV battery-2, respectively.

The waveforms illustrate both the reference and actual current over time. The reference current is set to 5 A, and the actual current closely follows this reference with minimal ripples, indicating the precision of the current controller. The graph underscores the controller's capability to rapidly adjust the d-axis current between 5 A and OA, facilitating the required power flow for charging the batteries.

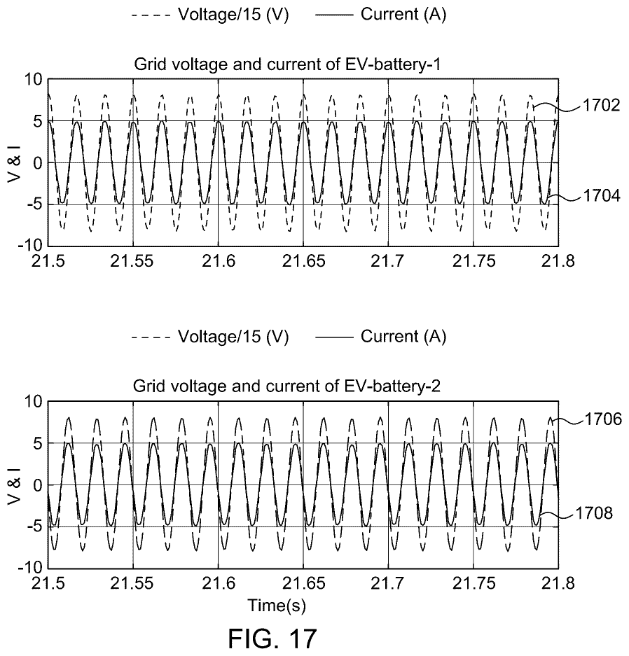

FIG. 17 is a graphical representation of the measured current and voltage waveforms for the same battery units while being charged. Curve 1702 depicts grid and curve 1702 depicts current of EV battery-1, respectively. Curve 1704 depicts grid and curve 1706 depicts current of EV battery-2, respectively. The voltage waveform is scaled down to match the current wave for clear comparison. Both graphs in FIG. 17 demonstrate the alignment of voltage and current waves, a condition indicative of unity power factor operation, which is essential for efficient real power transfer during battery charging. The absence of phase shift between the voltage and current waves confirms that the charging operation is conducted at unity power factor, corroborating the simulation outcomes.

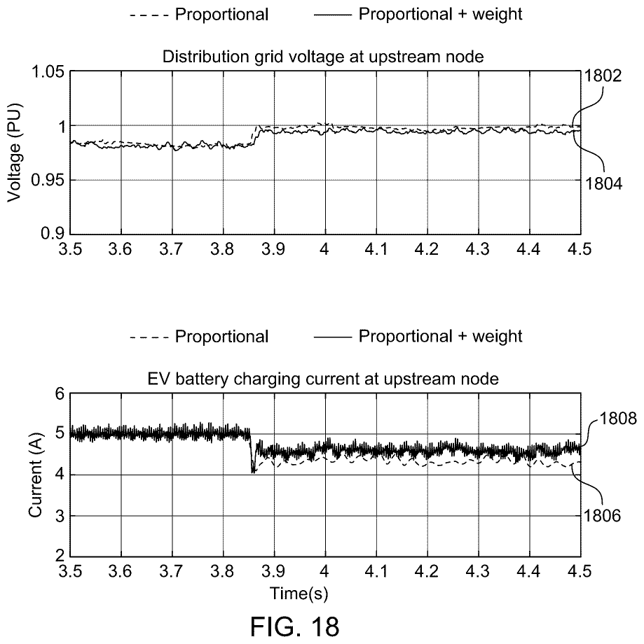

FIG. 18 depicts the autonomous charging control of an EV battery at the Upstream node, comparing the proportional and the proportional plus weight-based charging current control strategies. Curve 1802 depicts voltage obtained by the proportional control method and curve 1804 depicts voltage (pu) obtained by the proportional plus weight-based control method. Curve 1806 depicts current (A) obtained by the proportional control method and curve 1808 depicts current (A) obtained by the proportional plus weight-based control method.

The graph shows the voltage at the Upstream node is recorded at 0.98 per unit (pu). The proportional control results in a reduction of the EV charging current from 5 A to 4.3 A, whereas the proportional plus weight-based control leads to a smaller reduction, from 5 A to 4.5 A. This reduced current adjustment indicates the strategy's efficacy in maintaining higher current levels despite the decrease in node voltage.

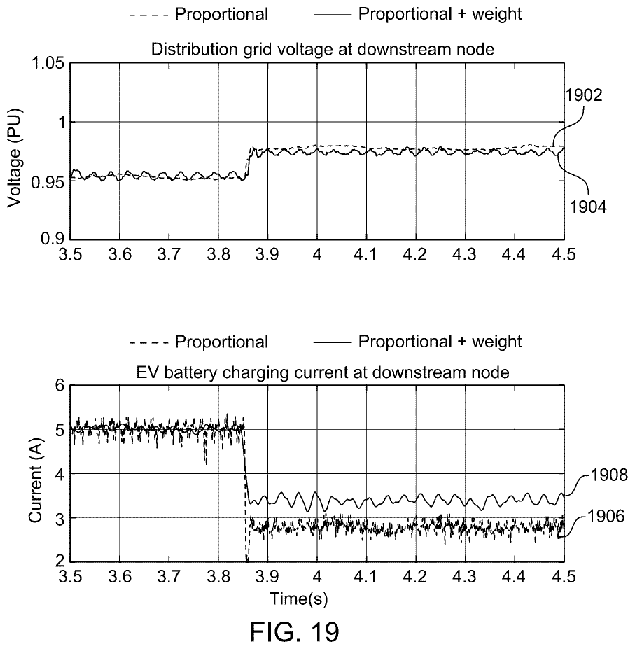

FIG. 19 illustrates the autonomous charging control at the Downstream node, in accordance with certain embodiments. Curve 1902 depicts voltage obtained by the proportional control method and curve 1904 depicts voltage (pu) obtained by the proportional plus weight-based control method. Curve 1906 depicts current (A) obtained by the proportional control method and curve 1908 depicts current (A) obtained by the proportional plus weight-based control method. Similar to FIG. 18, it provides a comparison of the two charging control strategies. The top graph shows the voltage at the Downstream node, which is observed at 0.955 pu. The proportional control reduces the charging current from 5 A to 2.8 A, whereas the proportional plus weight-based control limits the reduction to 3.5 A. Such adjustment shows that the proportional plus weight strategy is designed to mitigate the negative impact on the EV connected at the Downstream node by reducing the current to a lesser extent than the proportional control.

FIG. 18 and FIG. 19 demonstrate that the proportional plus weight-based control strategy leads to less reduction in charging current in response to a drop in node voltage. Consequently, this strategy results in a smaller difference in the grid voltage profile and minimizes the potential adverse effects on the battery charging process at the Downstream node. The voltage profile improvement is evident under both control strategies, yet the proportional plus weight-based control offers a comparative advantage in maintaining a more stable charging current.

In the present disclosure, a local charging control strategy is presented that operates autonomously and in a decentralized manner for EV batteries. The strategy takes into account factors, such as the local node voltage, the efficiency of charging, the battery's SOC, and the equitable management of charging among different EVs. The effectiveness of the controller and charger was initially verified using MATLAB simulations on a sizeable EV model, and subsequent real-time hardware validation was executed using a scaled-down lab setup. The performances from the simulated environment and the hardware setup were strikingly similar.

The various embodiments of the present disclosure, by modulating the charging current, have enhanced the voltage profile at the local node, particularly under conditions where the network is heavily loaded. EVs connected at downstream nodes prevented significant reductions in charging current due to the implementation of a weight-based charging current control method. The method also involves supplementing the charging current, which is proportionally reduced based on the voltage drop, with an additional weight to mitigate substantial reductions that would otherwise occur due to the proximity of a strong node.

The control system incorporates charging method based on both constant current and constant voltage to optimize charging efficiency and extend battery life. To assess the robustness of the controller, the location of the strong voltage node was altered. The charging setup employed a full bridge converter equipped with SiC-MOSFET switches, facilitating single-stage EV battery charging. A d_{q} frame control method was adopted for the autonomous regulation of charging currents in grid-connected batteries, leading to rapid response times, minimal steady-state error, and reduced overshoot in the control of battery current. Compared to traditional methods that reduce charging current proportionally, the proposed system exhibited a more equitable allocation of current among EVs. Furthermore, the system and hardware are capable of being expanded to support bidirectional energy flows from storage systems, aiding in the regulation of voltage and frequency. The integration of renewable energy sources into the system could also be explored to evaluate the impact of their intermittency and the potential enhancement of system performance when coupled with energy storage.

Numerous modifications and variations of the present disclosure are possible in light of the above teachings. It is therefore to be understood that within the scope of the appended claims, the invention may be practiced otherwise than as specifically described herein.

1. A method for controlling charging of a plurality of electric vehicles electrically connected to a power distribution system, comprising:
determining a voltage change tolerance based on a first local grid voltage of the power distribution system at a first time point and a second local grid voltage of the power distribution system at a second time point, wherein the first time point is prior to the second time point, and wherein the first and second local grid voltages are measured within a first range from a first electric vehicle of the plurality of electric vehicles located at an upstream node in the power distribution system;
measuring a third local grid voltage of the power distribution system at a third time point, a fourth local grid voltage of the power distribution system at a fourth time point, a first state of charge of the first electric vehicle of the plurality of electric vehicles at the fourth time point, a first battery voltage of the first electric vehicle of the plurality of electric vehicles at the fourth time point, wherein the third time point is prior to the fourth time point and after the second time point, and wherein the third and fourth local grid voltages are measured within the first range of the first electric vehicle of the plurality of electric vehicles;
comparing the first battery voltage and a first maximum battery voltage to determine a first charging mode of the first electric vehicle of the plurality of electric vehicles; and
determining a first charging current of the first electric vehicle of the plurality of electric vehicles based on the third and fourth local grid voltages, the first state of charge, and the first battery voltage.

2. The method of claim 1, wherein the first charging mode is selected from the group consisting of a minimum charging mode, a maximum charging mode, a variable charging mode, a constant charging mode, and a stop charging mode.

3. The method of claim 2, wherein the first charging mode is the variable charging mode and wherein the first charging current is determined in accordance with:
$${I}_{EV} = {I}_{m ax} - {k}_{p} min ( {ΔV}_{m ax} , ( {V}_{r} - {V}_{k} ( t ) ) + {μ}_{k} ( t ) ;$$
wherein I_{EV} is the charging current, Iₘₐₓ a maximum charging current, kₚ is a first scaling factor, ΔVₘₐₓ is maximum voltage deviation from a nominal grid voltage, Vᵣ is the nominal grid voltage, Vₖ(t) is the second local grid voltage, and μₖ(t) is a weight, wherein μₖ(t)=min (μₘₐₓ, b (Vᵣ-Vₖ(t)), wherein b is a second scaling factor and μₘₐₓ is a maximum weight.

4. The method of claim 3, wherein the weight is determined based on:
the third and fourth local grid voltages of the first electric vehicle of the plurality of electric vehicles measured within the first range from the first electric vehicle of the plurality of electric vehicles;
a fifth local grid voltage of the power distribution system at the third time point, a sixth local grid voltage of the power distribution system at the fourth time point, a second state of charge of a second electric vehicle of the plurality of electric vehicles at the fourth time point, a second battery voltage of the second electric vehicle of the plurality of electric vehicles at the fourth time point, wherein the fifth and sixth local grid voltages are measured within a second range from the second electric vehicle of the plurality of electric vehicles; and
wherein the second electric vehicle is located at a downstream node in the power distribution system.

5. The method of claim 4, wherein the measuring the third local grid voltage, the comparing, and the determining are repeated until the first charging mode is changed to the minimum charging mode, the maximum charging mode, the constant charging mode, or the stop charging mode.

6. The method of claim 5, wherein the upstream node and the downstream node in the power distribution system exclude a communication system for a decentralized charging control.

7. The method of claim 2, wherein the first local grid voltage is less than or equal to a threshold voltage, the first charging mode is the minimum charging mode, and the first charging current is a minimum current.

8. The method of claim 2, wherein the first local grid voltage is greater than the nominal grid voltage, the first charging mode is the maximum charging mode, and the first charging current is a maximum current.

9. The method of claim 2, wherein the first state of charge is greater than 80%, the first battery voltage is less than a maximum battery voltage, the first charging mode is the constant charging mode, and the first charging current is a pre-determined charging current value.

10. The method of claim 2, wherein the first state of charge is 100%, the first charging mode is the stop charging mode, and the first charging current is OA.

11. The method of claim 1, wherein the charging current is controlled by a Direct-Quadrature frame for an autonomous charging control.

12. A system for controlling charging of a plurality of electric vehicles electrically connected to a power distribution system, comprising:
a plurality of nodes including an upstream node and a downstream node connected to the power distribution system, wherein each node of the plurality of nodes has a sensor configured to measure a local voltage and a local current and is configured to charge the plurality of electric vehicles;
a microcontroller connected to the plurality of nodes configured to execute a program instruction, wherein the program instruction comprises:
determining a voltage change tolerance based on a first local grid voltage of the power distribution system at a first time point and a second local grid voltage of the power distribution system at a second time point, wherein the first time point is prior to the second time point, and wherein the first and second local grid voltage is measured within a first range from a first electric vehicle of the plurality of electric vehicles located at the upstream node in the power distribution system;
measuring a third local grid voltage of the power distribution system at a third time point, a fourth local grid voltage of the power distribution system at a fourth time point, a first state of charge of the first electric vehicle of the plurality of electric vehicles at the fourth time point, a first battery voltage of the first electric vehicle of the plurality of electric vehicles at the fourth time point, wherein the third time point is prior to the fourth time point and after the second time point, and wherein the third and fourth local grid voltages are measured within the first range of the first electric vehicle of the plurality of electric vehicles;
comparing the first battery voltage and a first maximum battery voltage to determine a first charging mode of the first electric vehicle of the plurality of electric vehicles; and
determining a first charging current of the first electric vehicle of the plurality of electric vehicles based on the third and fourth local grid voltages, the first state of charge, and the first battery voltage.

13. The system of claim 12, wherein the first charging mode is selected from the group consisting of a minimum charging mode, a maximum charging mode, a variable charging mode, a constant charging mode, and a stop charging mode.

14. The system of claim 13, wherein the first charging mode is the variable charging mode and wherein the first charging current is determined in accordance with:
$${I}_{EV} = {I}_{m ax} - {k}_{p} min ( {ΔV}_{m ax} , ( {V}_{r} - {V}_{k} ( t ) ) + {μ}_{k} ( t ) ;$$
wherein I_{EV} is the charging current, Iₘₐₓ a maximum charging current, kₚ is a first scaling factor, ΔVₘₐₓ is maximum voltage deviation from a nominal grid voltage, Vᵣ is the nominal grid voltage, Vₖ(t) is the second local grid voltage, and μₖ(t) is a weight, wherein μₖ(t)=min (μₘₐₓ, b (Vᵣ−Vₖ(t)), wherein b is a second scaling factor and μₘₐₓ is a maximum weight; and
wherein the weight is determined based on:
the third and fourth local grid voltages of the first electric vehicle of the plurality of electric vehicles measured within the first range from the first electric vehicle of the plurality of electric vehicles;
a fifth local grid voltage of the power distribution system at the third time point, a sixth local grid voltage of the power distribution system at the fourth time point, a second state of charge of a second electric vehicle of the plurality of electric vehicles at the fourth time point, a second battery voltage of the second electric vehicle of the plurality of electric vehicles at the fourth time point, wherein the fifth and sixth local grid voltages are measured within a second range from the second electric vehicle of the plurality of electric vehicles; and
wherein the second electric vehicle is located at the downstream node in the power distribution system.

15. The system of claim 14, wherein the measuring the third local grid voltage, the comparing, and the determining are repeated until the first charging mode is changed to the minimum charging mode, the maximum charging mode, the constant charging mode, or the stop charging mode.

16. The system of claim 15, wherein the upstream node and the downstream node in the power distribution system exclude a communication system for a decentralized charging control.

17. The system of claim 13, wherein the first charging mode is set to the minimum charging mode and the first charging current is set to a minimum current when the first local grid voltage is less than or equal to a threshold voltage;
wherein the first charging mode is set to the maximum charging mode and the first charging current is set to a maximum current when the first local grid voltage is greater than the nominal grid voltage;
wherein the first charging mode is set to the constant charging mode and the first charging current is set to a pre-determined charging current value when the first state of charge is greater than 80%, the first battery voltage is less than a maximum battery voltage; and
wherein the first charging mode is set to the stop charging mode, and the first charging current is set to OA when the first state of charge is 100%.

18. The system of claim 12, wherein the charging current is controlled by a Direct-Quadrature frame for an autonomous charging control.
